(19) United States
(12) Patent Application Publication
(10) Pub. No.: US 2020/0066126 A1
(43) Pub. Date: Feb. 27, 2020

(54) System, Apparatus And Method For Low Latency Detection And Reporting Of An Emergency Event

(71) Applicant: Silicon Laboratories Inc., Austin, TX (US)

(72) Inventor: Thomas Edward Voor, Cedar Park, TX (US)

(21) Appl. No.: 16/111,387

(22) Filed: Aug. 24, 2018

(51) Int. Cl. G08B 17/08; H04L 29/06; G05B 19/042; G08B 25/00; G08B 5/36

(52) U.S. Cl. CPC G08B 17/08; H04L 63/0428; G05B 19/042; H04L 67/12; G08B 5/36; G05B 2219/25257; G08B 25/00

(57) ABSTRACT

In one embodiment, an apparatus includes: an integrated circuit comprising a microcontroller to control operation of one or more light sources and a wireless transceiver to enable communication between the apparatus and a remote service provider; and at least one microphone coupled to the integrated circuit to detect audio information. In response to receipt of a first audio sample, the microcontroller can detect an emergency event and communicate an indication of the emergency event to the remote service provider.

### BACKGROUND

With ever greater numbers of mass shootings, terrorist attacks, natural disasters and other emergency events, many buildings and other locations are incorporating video cameras and other surveillance equipment. Typically these cameras communicate into a central system at the building, where video may be monitored by security personnel. In the case of an attack, such personnel may notify emergency responders and/or take other measures. Also, either by way of on-site security personnel or via an automated system, alarms may be triggered to give general warnings or voice announcements as to a description of the emergency and instructions. However, during an emergency, building inhabitants may not accurately hear or understand directions.

Furthermore, while video from a surveillance camera can be provided to remote entities such as emergency responding personnel, typically by the time appropriate personnel review the video surveillance information, it is outdated and of little use.

### SUMMARY OF THE INVENTION

In one aspect, an apparatus includes: an integrated circuit comprising a microcontroller to control operation of one or more light sources and a wireless transceiver to enable communication between the apparatus and a remote service provider; and at least one microphone coupled to the integrated circuit to detect audio information, where in response to receipt of a first audio sample, the microcontroller is to detect an emergency event and communicate an indication of the emergency event to the remote service provider.

In an example embodiment, in response to the indication of the emergency event, the one or more light sources are to display a predetermined color. The microcontroller may compare the first audio sample to a gunshot signature to determine whether a gunshot has occurred in a vicinity of the apparatus. And, in response to this comparison, the apparatus is to communicate the indication of the emergency event comprising the gunshot to the remote service provider. Also, the apparatus may communicate a stream of audio information from the microphone to the remote service provider.

In an example embodiment, the integrated circuit, after the communication of the emergency event indication, may receive an interrogation request from the remote service provider, decrypt the interrogation request, prepare an interrogation response, encrypt the interrogation response and send the encrypted interrogation response to the remote service provider. The microcontroller may encrypt the emergency event indication with a hidden key and send the encrypted emergency event indication to the remote service provider based on destination information stored in a local policy. The apparatus may further include at least one sensor to sense an environmental condition. The microcontroller in turn may detect at least one other emergency event in response to an input received from the at least one sensor, and communicate an indication of the at least one other emergency event to the remote service provider. In response to the emergency event detection, the microcontroller is further to send control information to one or more Internet of Things (IoT) devices in communication with the apparatus to cause the one or more IoT devices to take an action according to a policy. The control information may cause a first IoT device comprising an actuator to lock a door. The apparatus may be a smart bulb, and the detection of the emergency event comprises an indication of at least one keyword in the audio information that matches a predetermined keyword.

In another aspect, a method includes: receiving, in a computing system of a service provider, a secure communication sent from a smart bulb located in a building remote to the service provider, the secure communication comprising an emergency alert for an emergency occurring in the building; identifying a location of the smart bulb within the building based at least in part on an identifier associated with the smart bulb; accessing a policy database for an entry associated with the building; and based at least in part on policy information in the policy database entry, sending an emergency alert and location information regarding the location of the smart bulb to at least one emergency authority identified in the policy information.

In an example embodiment, the method further comprises: verifying that the secure communication is received from the smart bulb located at an expected location; and responsive to not verifying that the smart bulb is located in the expected location, discarding the secure communication. The method also may further include: correlating status information obtained from one or more other smart bulbs co-located within a first proximity of the smart bulb; partitioning a plurality of smart bulbs within the building into a plurality of groups based at least in part on relative distance from the smart bulb; and sending control messages to the plurality of groups to cause corresponding smart bulbs within each of the plurality of groups to operate in different manners based at least in part on the relative distance. The method may further include comprise causing each of the plurality of groups to operate with different colors. In an example, the method further includes causing a first group of the plurality of groups to operate in a flashing mode, where the first group is within a first proximity of the smart bulb.

In yet another aspect, a system includes: a plurality of first smart bulbs adapted in a building, each of the plurality of first smart bulbs having a unique identifier associated therewith; a plurality of second smart bulbs adapted in the building, each of the plurality of second smart bulbs having a unique identifier associated therewith and comprising a microcontroller to control operation of one or more light sources of the second smart bulb and a wireless transceiver to enable communication between the second smart bulb and a remote service provider; where a first one of the plurality of second smart bulbs is, in response to receipt of a first audio sample, to detect an emergency event and communicate an indication of the emergency event to the remote service provider; and where the plurality of first smart bulbs, in response to control information from the remote service provider generated in response to the indication of the emergency event, are to operate at one or more colors, to indicate relative proximity to the emergency event.

In an example embodiment: a first portion of the plurality of first smart bulbs are to operate at a first color to indicate a first distance with respect to the first one of the plurality of second smart bulbs that indicated the emergency event; and a second portion of the plurality of first smart bulbs are to operate at a second color to indicate a second distance with respect to the first one of the plurality of second smart bulbs that indicated the emergency event.

Note that the system may further include a first mesh network including at least some of the plurality of first smart bulbs and at least one of the plurality of second smart bulbs. And, the at least one of the plurality of second smart bulb may provide control information to the at least some of the plurality of first smart bulbs, the control information including synchronization information.

### BRIEF DESCRIPTION OF THE DRAWINGS

FIG. 1 is a block diagram of a smart bulb in accordance with an embodiment.

FIG. 2 is a high level diagram of a network in accordance with an embodiment.

FIG. 3 is a flow diagram of a method in accordance with one embodiment.

FIG. 4 is a flow diagram of a method in accordance with another embodiment.

FIGS. 5A and 5B are flow diagrams of a method in accordance with another embodiment.

FIG. 6 is a flow diagram of a method in accordance with another embodiment.

### DETAILED DESCRIPTION

In various embodiments, a smart light bulb (referred to herein generally as a “smart bulb”) or another Internet of Things (IoT) device may be configured with circuitry to receive audio samples or other environmental samples from an environment in which the smart bulb/IoT device is located. For purposes of discussion, embodiments using a smart bulb and audio information are described. However, understand that the disclosed subject matter is applicable to a wide variety of IoT devices. Based at least in part on such audio sample information, the smart bulb may be configured to detect an emergency event occurring in a vicinity of a location of the smart bulb. For a particular embodiment described herein, this emergency event may be a gunshot occurring in the vicinity. However, understand that various emergency events, ranging from fire, glass breaking, explosion, earthquake-induced building failures, imminent lightning strike or so forth can be identified. As such, a smart bulb may include, in addition to a microphone and/or other audio sensor, one or more additional sensors such as a heat sensor, motion sensor, environmental sensor(s) such as a carbon monoxide sensor, or so forth.

When an emergency event is detected, the smart bulb may communicate an indication of this emergency event to a destination. Although in many cases this destination may be a remote service provider with which the smart bulb may communicate, in some cases the indication may be sent alternatively or in addition to a local entity, such as a building automation system or so forth. Further, understand that in cases where the smart bulb communicates an indication to the remote service provider, such communication may be via one or more intermediate entities, such as a hub, router, access point or so forth with which the smart bulb is in communication.

In turn, the remote service provider or other entity receiving this indication of an emergency alert may first verify the trustworthiness of the indication. Note the gravity of a response needed for various types of emergencies requires a high degree of trust in the ability of a system to maintain a high degree of security, reliability in detection, tamper prevention, high authenticity of emergency alerts, and installation location accuracy. Specifically, the remote service provider may confirm that the indication was received from a trusted device located at an expected location. In addition, the remote service provider may take various actions based on this emergency alert indication. As one such action, the remote service provider may send an emergency communication to one or more emergency responder entities, such as police department, fire department or so forth.

In addition, the remote service provider may provide control instructions back to the smart bulb, and potentially to additional smart bulbs or other IoT devices in the same building or other location, to cause various actions to take place. For example, based on location information identifying the exact location at which the gunshot or other emergency event was detected, the remote service provider can send control information to cause appropriate emergency lighting to inform both individuals in the vicinity of the emergency event and emergency responders as to the location of the emergency event and direction(s) of best escape route from the location. For example, the control information may cause the smart bulb that detected the gunshot to flash with a highest warning color, e.g., red. In turn, smart bulbs in close proximity with this smart bulb may similarly be controlled to flash the same color. As other smart bulbs become more physically removed from the initial detection smart bulb, different colors may be displayed, e.g., from orange to blue to green, indicating routes to safety.

As an example, an emergency indication may be for single color lights to blink, strobe, flash, or gradually oscillate illumination intensity in various patterns. The periodicity, rate of illumination intensity change, and duty cycle of flashing can indicate distance from the detected emergency. Also, the flashing of lights can be coordinated with neighboring lights like peristalsis, or animation. Coordination of blinking can indicate direction toward the emergency, or toward the safe exit routes depending on the type of emergency, the building, and relevant policy. Slow and gently changing illumination intensity can indicate safe exits, and rapid flashing with harsh changing illumination intensity can indication location of emergency.

Note that such indications for the different locations can be pre-configured by a given entity. In turn, the entity (such as a school) may perform active shooter training of its students to enable the students to understand and appropriately respond to the emergency lighting provided in an actual emergency situation so that they may best seek a safe location. Also methods may be performed for a building authority to routinely run tests of an emergency system, and or an emergency drill for building (similar to fire drill evacuation) but with coordination between all agencies involved for a given policy (e.g., police, fire, building security, administration, etc.).

Note further that the remote service provider may provide control information to additional IoT devices, such as actuator devices, e.g., door or window locks. To this end, depending upon the given policy and location information, a location with a potential active shooter may be isolated from a remainder of the building by way of such locks or other actuating means.

As further examples, in response to a triggering event other IoT devices may be activated, including cameras to record both video and still images. As another example, lights can be controlled to brighten momentarily synchronized with a still camera shutter. Such IoT cameras can be accessed remotely during an emergency event, and images can be stored locally for evidence in case a network is not reliable, e.g., due to limitations with low data rate, low bandwidth, high latency, network congestion, or loss of power.

The communication from the smart bulb to the remote service provider may be sent with low latency and a minimal amount of data, such that the communication may occur nearly instantaneously. In turn, the remote service provider may be configured to similarly verify the indication with low latency and provide emergency responders with a notification nearly instantaneously, enabling a more rapid response than otherwise possible with a conventional alarm system, video surveillance operation or so forth, all of which may suffer from high latency and low bandwidth, as well as a greater potential for misuse.

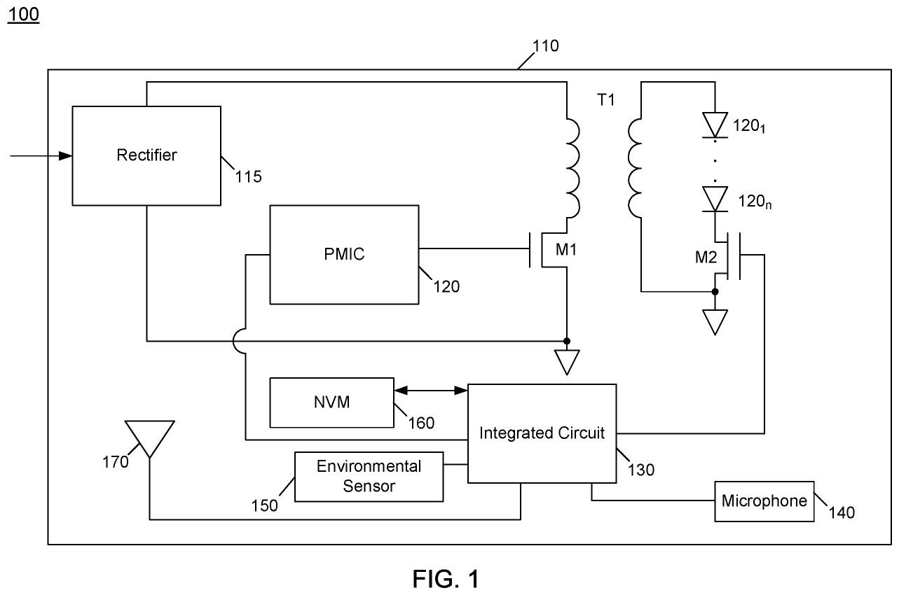

Referring now to FIG. 1, shown is a block diagram of a smart bulb in accordance with an embodiment. As shown in FIG. 1, smart bulb 100 is formed in a housing 110, which may take any form desirable for inclusion into a given electrical socket. For example, a smart bulb may be configured having a shape like a conventional incandescent bulb with a screw threaded mechanism to fit into a legacy light socket. Or any other appropriate shape and size for incorporation into different types of lighting sockets are possible. As illustrated, housing 110 includes a set of series-coupled LEDs 120₁-120_{N} which provides illumination. In different embodiments herein, LEDs 120 may be controlled to operate at different wavelengths to provide lighting of different colors, depending upon a particular emergency condition and location, as well as providing a desired wavelength for normal operation.

As further illustrated, smart bulb 100 includes at least one integrated circuit (IC) 130. In embodiments, integrated circuit 130 may be implemented with a single semiconductor die that includes various control and communication circuitry. In one particular embodiment, this control circuitry may be implemented as a microcontroller (MCU) configured to programmably execute instructions for operation of smart bulb 100 both in normal operation and responsive to detection of an emergency event. To this end, IC 130 may be coupled to a non-volatile memory 160 including instructions to execute the various detection and control operations, including to provide control of smart bulb 100 in different modes as described herein. Note that these instructions may be provided as firmware stored in non-volatile storage of the MCU or otherwise within IC 130. In other cases, software-based instructions for execution may be stored in an appropriate storage such as non-volatile memory 160 or another location. Integrated circuit 130 further may include communication circuitry such as RF circuitry to enable wireless communication according to possibly multiple different wireless communication protocols, via an antenna 170 coupled to integrated circuit 130. In addition, communication circuitry 130 further may be included to enable wired communications, depending upon a particular network in which a smart bulb is located.

As further illustrated, to provide sensor-based inputs, smart bulb 100 may include or be associated with a variety of different sensor types, as discussed above. In one relevant aspect herein, smart bulb 100 may include a microphone 140. Such microphone may be an ultrasonic or sound processor sensor that is sensitive to frequencies above and below those of normal speech, but not able to eavesdrop on conversations. Or in other cases another type of audio sensor also may be provided. Note that microphone 140 may be configured to ensure privacy of audio information other than in the case of emergency events. For example, microphone 140 and/or smart bulb 100 may be configured with security designations to provide privacy of audio information prior to and after detection of an emergency event. Such configuration also may be based on a location in which smart bulb 100 is located. For example, privacy may be set at a relatively high level for an individual's office to prevent eavesdropping on conversations. Or microphone 140 may be configured to muffle audio quality such that conversations cannot be heard or detected. Instead when microphone 140 is configured for incorporation into a more public area such as a hallway, common area or so forth, its configuration may enable higher audio quality such that conversations may be heard.

In other cases, microphone 140 may be a microphone configured with a slightly more powerful processor when installed in a public location. In this way the microphone can sample audio inputs to identify predetermined key words within speech. Based on such information, smart bulb 100 may provide a silent alert to local authorities with an indication of the spoken one or more identified key words. These local authorities could be teachers, counselors, PE coach, principal or so forth. Such recorded speech may also be used to provide information that can be used to better select or prepare responders, or speed up relevant response time and urgency if it escalates. Example key words could include “Gun”, “Shooter”, “Fire”, “Bomb” or so forth. In some cases, a processor associated with microphone 140 may be configured to detect heightened exertion of people shouting these words and also provide an alert level. Again location can be provided to responders, and response can be dictated by a policy. With this feature, a principal can decide if he wants anyone to be alerted if “Gun!” is yelled multiple times in a location. Policy settings can provide a means to ignore yelling of “Fight Team Fight” near the gym, for example. However, yelling of “Fight” in the library could send low alert triggers to teachers nearby to have a look.

Additional sensors within smart bulb 100 may include at least one environmental sensor 150 such as a light sensor that may be configured to detect a muzzle flash, or other appropriate sensors such as infrared sensor to sense heat or other conditions. Additional sensors may include: room occupancy sensors using either passive infrared or active ultrasonic sensors; flash detection using infrared or electro-optical sensors; and heat detection and smoke detection sensors. A power management integrated circuit (PMIC) 120 may be provided. In general, PMIC 120 may include electrical ballast for light bulb 100 and may control provision of power, received via a rectifier 115, to LEDs 120₁-120_{N}, via a transformer T1. To this end, PMIC 120 may control a first MOSFET M1 to provide power to LEDs 120₁-120_{N}.

Still further, IC 130 may receive wireless commands for control modes for light bulb 100. For example, IC 130 may receive wireless control signals, e.g., from a given user device, such as a building automation control system, a smartphone application that executes on a user's smartphone or via a remote service provider as described herein. Further, understand that via IC circuit 130, health and other status information regarding light bulb 100 may be communicated to various destinations, such as a building automation control system. Furthermore, based upon control signals, e.g., received wirelessly, IC 130 may control operating modes of LEDs 120₁-120_{N} via control of another MOSFET M2. For example, temperature-based compensation, color balancing, dimming, warning-based coloring or lighting patterns and so forth may be controlled. Note that different wireless communication protocols may be used to communicate with IC 130, such as Z-Wave, Thread, Zigbee™ or Bluetooth™ low energy protocols, for example.

More particularly, depending upon a given implementation of smart bulb 100 within a given system, different communication techniques may be used. For example, smart bulb 100 may be coupled in a mesh network with additional smart bulbs or other IoT devices. In such a configuration, multiple devices may connect in a wired or wireless manner, with a single one of these multiple connected devices in turn coupled to communicate with remote systems, such as a remote service provider via an internet connection. In another implementation, smart bulb 100 may communicate wirelessly according to a given wireless local area network such as a Wi-Fi™ network to a given access point that in turn may communicate with a remote service provider via the Internet. In yet another implementation, smart bulb 100 may communicate wirelessly in a short range, such as according to a Bluetooth™ protocol, to a hub device that in turn may communicate with the remote service provider via the internet. Of course other types of communication techniques may occur. For example, a given smart bulb or a mesh network to which the smart bulb is coupled in turn may communicate (either wired or wirelessly) with a local controller that in turn communicates with a remote service provider via the internet. To this end, IC 130 includes upper level MAC circuitry. Although not shown for ease of illustration, understand that in another implementation, an additional integrated circuit, such as a locally included coprocessor such as a network coprocessor, may be present within a smart bulb or other IoT device to perform over-the-air wireless communications. In such implementation, this network coprocessor may include lower level MAC circuitry. Understand while shown at this high level in the embodiment of FIG. 1, many variations and alternatives are possible. For example, while the discussion herein is of a smart bulb as an exemplary embodiment, understand that other embodiments may incorporate the techniques herein in lighting fixtures, to effect an implementation in which smart light control is realized by inclusion of MCU, radio and antenna in a light fixture.

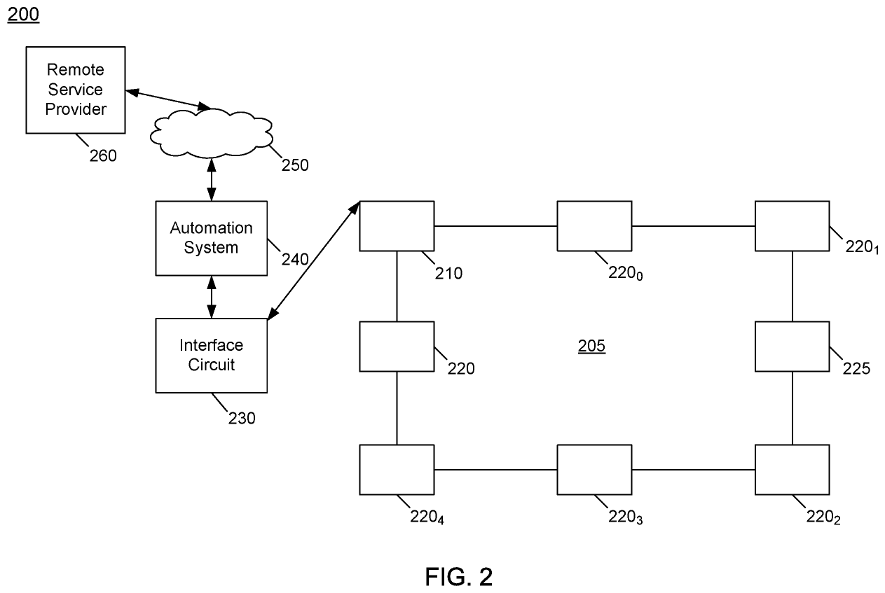

Referring now to FIG. 2, shown is a high level diagram of a network in accordance with an embodiment. As shown in FIG. 2, a network 200 includes a variety of devices, including smart devices such as smart bulbs and/or other IoT devices, interface circuits, automation systems, and remote service providers. In the embodiment of FIG. 2, a plurality of IoT devices are coupled in a mesh network 205. For purposes of illustration, assume that mesh network 205 is present within a given room, e.g., a classroom. In mesh network 205, a first smart bulb 210 may be configured as described herein with a microphone and/or other environmental sensors to sense an emergency event. To provide an emergency alert, smart bulb 210 couples, e.g., via a wired or wireless link, to an interface circuit 230. In different embodiments, interface circuit 230 may be a hub device, access point, router or so forth. In turn, interface circuit 230 may be in communication with an automation system 240, such as a building automation system. Again, this communication path may be a wired or wireless link, such that information may travel bidirectionally between interface circuit 230 and automation system 240. Note that interface circuit 230 may be present within the room itself. Understand that interface circuit 230 may communicate with multiple mesh networks.

As further illustrated in FIG. 2, smart bulb 210 may communicate via mesh network 205 with other smart devices, including a plurality of other smart bulbs 220₀-220₄. Note that smart bulbs 220 may be less fully featured smart bulbs, such as lacking internal microphones or sensors. As described herein, when smart bulb 210 is caused to light with a particular pattern, it may also communicate control information to smart bulbs 220 to enable them to light with a similar pattern.

Mesh network 205 also includes additional IoT devices 220, 225. In different embodiments, IoT devices 220, 225 may be implemented as actuators, e.g., door locks, window locks or so forth. When a particular type of emergency event is indicated, smart devices 220, 225 may be controlled or actuated, e.g., to lock. Note that an MCU of these and other IoT devices can also incorporate the ability to accurately synchronize time with other IoT devices nearby, on the same local area network or mesh network. This ability may help multiple sensors to triangulate onto the origin of the emergency, and enhance emergency detection discrimination (or eliminate false detections using redundancy or timing information).

Still with reference to FIG. 2, note that automation system 240 may be in communication with a remote service provider 260 via a wide area network 250, e.g., the internet. In this way, low latency communication of an emergency event can be sent to remote service provider 260 for handling. In addition, remote service provider 260 may, based at least in part on policy information for the detected emergency event associated with the building, send control information back to automation system 240 to enable control of smart devices as described herein. Understand while shown at this high level in the embodiment of FIG. 2, many variations and alternatives are possible.

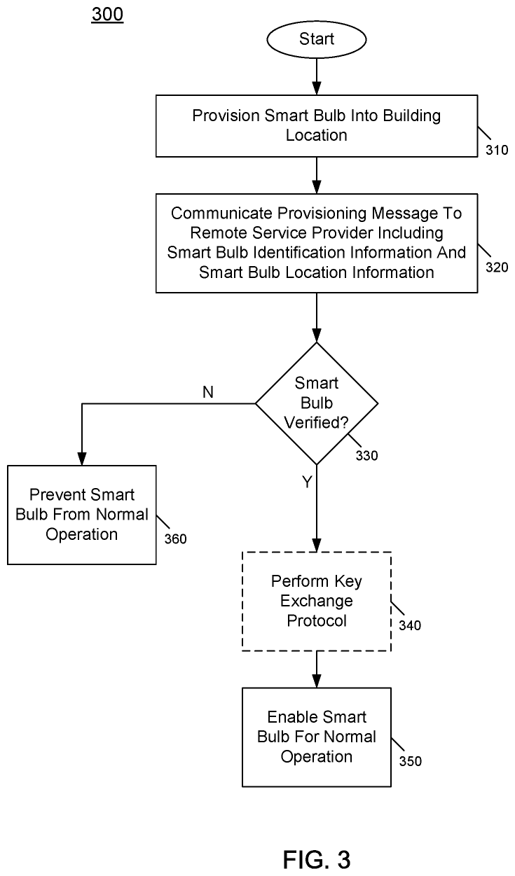

Referring now to FIG. 3, shown is a flow diagram of a method in accordance with one embodiment. More specifically FIG. 3 is a provisioning method to enable a smart bulb to be incorporated into a light fixture in a building, assure its authenticity and trust, and create and maintain a record for the smart bulb in a database of, e.g., a remote service provider. As such, method 300 may be performed by hardware circuitry, firmware, software and/or combinations thereof. In a particular implementation, method 300 may leverage smart capabilities within the smart bulb, as well as at least one control device, e.g., a laptop or tablet computer that in turn may communicate with a remote service provider.

As illustrated, method 300 begins by provisioning the smart bulb into a building location (block 310). For example, a technician may install a smart bulb into a light fixture in a given room of a building. For purposes of discussion herein, assume that the building is a school building and the room is a given classroom. Although multiple other light bulbs including smart bulbs may be installed in this particular room, in applications herein a single smart bulb within the room may be provided with a microphone to enable the acoustic detection of gunshots or other emergency events. Understand that the technician may perform various provisioning operations when installing the smart bulb into the fixture. To this end, the smart bulb may be in, e.g., wireless communication with a computing device of the technician such as a tablet computer on which a provisioning application may execute. Such provisioning application may, in an embodiment, be provided as a configuration console of a IoT architectural framework including various software and firmware layers to provide an interface between individual IoT devices and one or more backend systems, whether they be local control systems (such as a building automation system) or a remote system, such as provided by a remote service provider.

As part of this provisioning, smart bulb identification information may be communicated to a remote service provider in a provisioning message (block 320). For example, a smart bulb may include a unique identifier, e.g., stored in a fuse or other non-volatile storage within the smart bulb, such as internally to an MCU in non-volatile, encrypted secure element. In addition to this identification information, a location of the smart bulb may be communicated to the remote service provider (block 330). Note that this location may be obtained using GPS information, and/or map information or so forth. At a minimum, this location information may identify a location within the building at which the smart bulb is installed, e.g., a particular location within a classroom, classroom number, location on a given floor, wing or other building partition.

Next it is determined at diamond 330 whether the smart bulb is verified. To this end, the remote service provider may cross check the identification information with a list of known valid identifiers, e.g., as received from the smart bulb manufacturer or by the provisioner. If the smart bulb has been verified as valid, control may pass to optional block 340 where a key exchange protocol may be performed between the smart bulb and the remote service provider. To this end, a given key exchange protocol may be performed to enable generation of a shared key such as a symmetric key to be shared by these two entities. In other cases, an asymmetric key sharing protocol may be performed to enable communication between the entities of public keys, with private keys being maintained internally to the individual devices so that future communications can proceed in an encrypted or otherwise protected manner.

Thereafter at block 350 the smart bulb is enabled for normal operation. In some embodiments, prior to enabling the smart bulb, a local policy can be stored in a secure storage of the smart bulb. This local policy may be accessed in the instance of detection of a triggering event to identify appropriate handling procedure (e.g., reporting of a gunshot, etc.). To this end, at block 350 coordination may occur between the smart bulb and the remote service provider to create and store into the smart bulb a predetermined local policy of what to do during an emergency detection.

Note that similar coordination may occur between other system components such as local network or mesh elements and the remote service provider. And a local policy can have the ability of gunshot detectors (and other emergency detectors), to enable a smart bulb to immediately change to alert configuration without communicating to or from the remote service provider. Some or all smart bulbs may be given privileges to change the neighboring smart bulbs into the policy-based emergency condition over a local area network or mesh network without needing communication with or intervention from remote service. Understand that the policy may further dictate validation steps of the remote service provider, what the remote service provider responsibilities are, and who and what are notified in the case of a triggering event, where audio and other data are forwarded and so forth. Understand that in some embodiments the policy may further dictate maintenance and implementation operations. If the smart bulb is not verified, control passes to block 360 where the smart bulb may be prevented from normal operation.

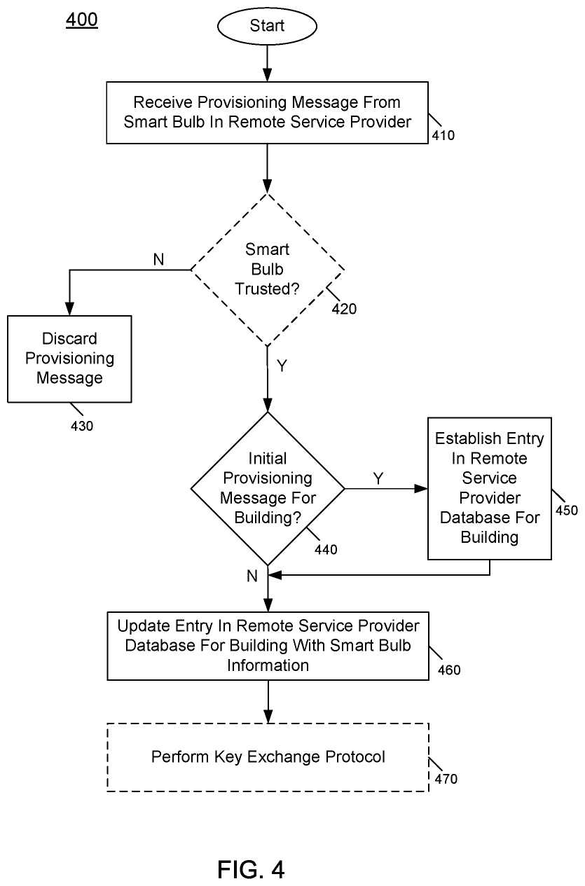

Referring now to FIG. 4, shown is a flow diagram of a method in accordance with another embodiment of the present invention. More specifically, method 400 of FIG. 4 is a method for operating a smart bulb as described herein. As such, method 400 may be performed by hardware circuitry, firmware, software and/or combinations thereof.

As illustrated, method 400 begins by receiving a provisioning message from the smart bulb in the remote service provider (block 410). As discussed above, this provisioning message may include various information to identify the smart bulb and its location. Based at least in part on this information, the remote service provider may optionally determine whether the smart bulb is trusted (diamond 420). In instances where this provisioning message is received in an unencrypted manner, this trust determination may be based at least in part on the identification information and location information that indicates that the provisioning message is received from an expected smart bulb generally located in an expected location. Note that if the smart bulb is not trusted at this determination operation, control may pass to block 430 to discard the provisioning message.

Assuming that the smart bulb is trusted, control passes to diamond 440 to determine whether this provisioning message is an initial message for a building in which the smart bulb is located. If so, control passes to block 450 where an entry may be established for the building in a database of the remote service provider. That is, a remote service provider may maintain a database to store information for many different buildings or other locations, where each such entry itself in turn is formed of multiple records, such as a given record or subentry for each smart bulb or other IoT device with which the remote service provider may communicate.

In any event, control next passes to block 460 where the entry for this building may be updated with the smart bulb information. Such information may include the smart bulb identification information and location information, such that the remote service provider can determine in response to an emergency alert indication, the particular location of this smart bulb and its relative location with regard to other smart bulbs or other IoT devices. As such, the remote service provider may generate a record for the smart bulb that associates the smart bulb with its location information, capability information, status information and so forth. Understand that during normal operation, routine status messages may be sent from the smart bulb to the remote service provider to indicate health of the smart bulb and can be used to update the status information.

Also understand that the database may further include security information for the smart bulb. As one example, communications between the smart bulb and the remote service provider may be encrypted in accordance with, e.g., public key infrastructure (PKI)-based cryptographic operations. To this end, the remote service provider and the smart bulb may as part of the provisioning process perform a key exchange protocol such that a shared key may be established for use by these entities. Or the entities may provide each other with a public key and maintain in secrecy a corresponding private key such that communications between the devices may be appropriately encrypted and decrypted. To this end, as further illustrated in FIG. 4, method 400 optionally may further perform a key exchange protocol (block 470). In this way, the entities (remote service provider and smart bulb) may share key information so that future communications between these entities may be appropriately encrypted or otherwise protected. Understand while shown at this high level in the embodiment of FIG. 4, many variations and alternatives are possible.

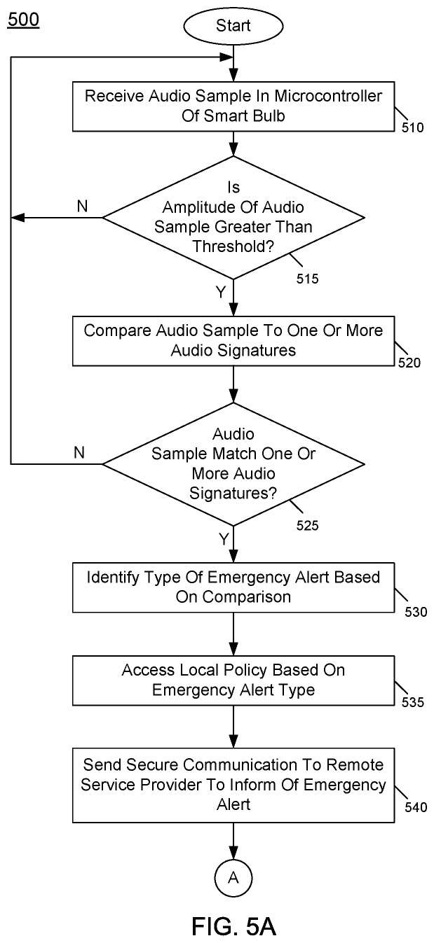

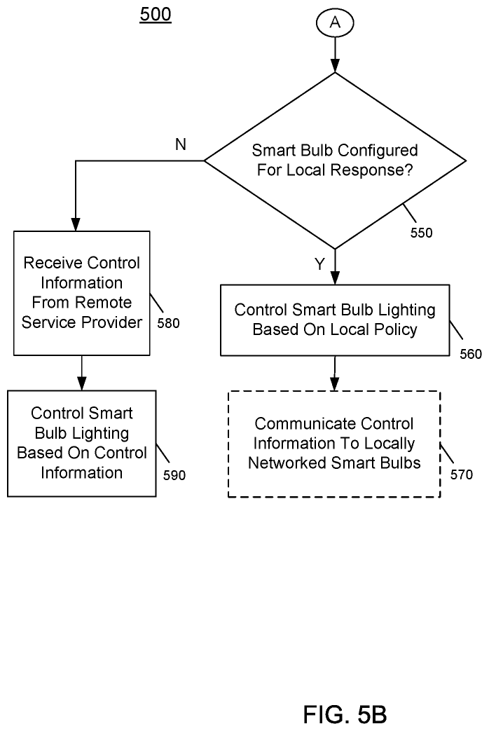

Referring now to FIGS. 5A and 5B, shown are flow diagrams of a method in accordance with another embodiment. More specifically, method 500 is a flow diagram of a method for detecting an emergency event using a smart bulb as configured herein. As such, method 500 may be performed by hardware circuitry, firmware, software and/or combinations thereof. In a particular embodiment, method 500 may be performed by a microcontroller of a smart bulb that programmably executes instructions stored in a given non-transitory storage medium, such as a flash memory or so forth. As illustrated, method 500 begins by receiving an audio sample in a microcontroller of the smart bulb (block 510). As described herein, this audio sample may be received in the smart bulb via one or more microphones or other audio sensors (in addition to other sensors) to receive sensor input during normal operation. Further, understand while method 500 is described with regard to handling of audio sample information, embodiments are not so limited and similar techniques may be used for processing other sensor information to identify emergency events.

Still with reference to FIG. 5A, control passes to diamond 515 to determine whether the amplitude of the audio sample is greater than a threshold. If the amplitude does not exceed this threshold, no further operations occur with regard to this particular audio sample, and control passes back to block 510.

When it is determined that the audio sample has an amplitude greater than the threshold, control passes to block 520 where the sample can be compared to one or more audio signatures. Such audio signatures may be stored in non-volatile memory and can be accessed in this instance, e.g., in serial fashion, to compare the received audio sample to such signatures. Note that different audio signatures may be associated with different emergency events, including gunshot activity, fire, glass break or so forth.

Assume for purposes of discussion that the audio sample is indicative of gunshot activity. As such, at diamond 525 it is determined that the audio sample matches a given audio signature that is associated with gunshot activity. As such, next at block 530 a type of emergency alert may be identified based on the comparison. Thus in this instance when the comparison indicates a match, e.g., to a predetermined level with a gunshot signature, this emergency alert may be identified as gunshot activity. Thereafter, control passes to block 535 where a local policy may be accessed based on the emergency alert type. That is, the smart bulb may include or may be associated with a local policy storage that stores various policy information that can be accessed in response to an indication of a particular type of alert. Such policy information may include but is not limited to an indication of one or more operations to be performed by the smart bulb for the given emergency type.

As further illustrated in FIG. 5A, based upon the policy information associated with the particular emergency alert type, at block 540 a secure communication may be sent to the remote service provider to inform of the particular emergency alert. For example, with reference to gunshot activity, the secure communication may indicate an alert type that identifies gunshot activity, a location of the smart bulb, other identifying information and so forth. Furthermore, understand that this communication may be secure. As one example, the communication can be encrypted according to the key exchange described above. To provide even greater security assurances, the local policy may indicate that for at least certain emergency alert types, a different, hidden key be used for encrypting this communication. Such hidden key may be a key unique to the particular smart bulb. This hidden key may be written into an integrated circuit of the smart bulb during manufacture of that integrated circuit (or incorporation of the integrated circuit into the smart bulb) as an emergency alert key, only to be used for a secure communication of an emergency alert. To this end, this hidden key, in an implementation in which it is a symmetric key, also may be provided from the manufacturer to the remote service provider so that upon provisioning of the smart bulb into a particular building, an association of the hidden emergency alert key with a record of the sent bulb can occur. In some cases with such hidden key, a double encryption or wrapping may occur such that the emergency alert indication can first be encrypted with this hidden key and thereafter encrypted with a private key of a PKI-based encryption scheme. In any event, at block 540 the resulting secure communication is sent to the remote service provider. Understand that as this communication includes a very limited amount of data, the communication may occur in real time and with minimal latency, as very limited bandwidth is needed for the communication.

Method 500 continues on FIG. 5B. As illustrated, next it may be determined whether the smart bulb is configured for a local response (diamond 550). For example, the policy information may further identify what if any actions the smart bulb is to take in response to the particular type of emergency alert. Again in the case of gunshot activity, the policy information may indicate that the smart bulb is to light up with a particular color, pattern or so forth. Assuming there is such local response indicated, control passes to block 560 where the smart bulb lighting may be controlled based on this local policy. For example, for the smart bulb that detects the gunshot activity, it may be controlled to flash red to indicate the danger. As further illustrated, control may pass to optional block 570 where additional control information, e.g., obtained from the local policy, may be communicated to locally networked smart bulbs. For example, a single smart bulb in a room, hallway or other location configured with a microphone can communicate the same control information to other smart bulbs within a limited proximity to cause them to operate in the same manner (e.g., flashing red).

Still with reference to FIG. 5B, instead if there is no information for a local response, control passes to block 580 where control information may be received from the remote service provider. Again understand that this communication may be encrypted (e.g., with the shared keys). Thereafter at block 590 the smart bulb lighting may be controlled based on this control information, which may similarly call for a particular color and pattern to be displayed. Understand while shown at this high level in the embodiment of FIGS. 5A and 5B, many variations and alternatives are possible. Additional control information may be received and used to control operation of the smart bulb or other co-located devices. For example, the control information may indicate to the smart bulb that it is to stream audio information obtained via the microphone, such that audio information in the vicinity of the emergency detection, e.g., gunshot activity, may be provided to emergency responding personnel, both for purposes of verification of authenticity, as well as for use in responding to the gunshot.

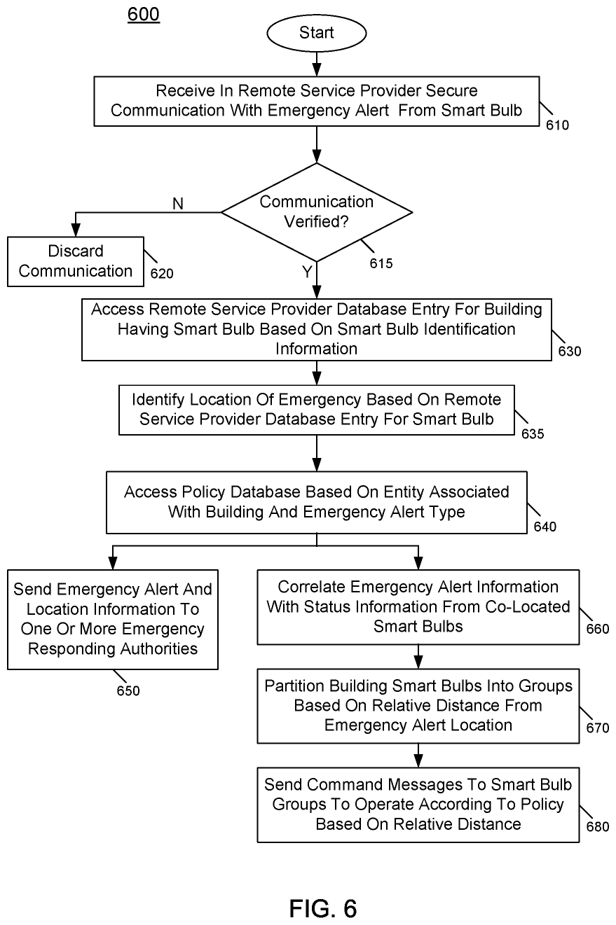

Referring now to FIG. 6, shown is a flow diagram of a method in accordance with another embodiment. As illustrated in FIG. 6, method 600 is a method for handling an emergency event indication received in a remote service provider. As such, method 600 may be performed by hardware circuitry, firmware, software and/or combinations thereof. In a particular embodiment, method 600 may be performed by one or more servers and other computer hardware of a remote service provider, which may be implemented in a cloud computing environment. Such server(s) may include one or more hardware processors to programmably execute instructions stored in a given non-transitory storage medium. This cloud computing environment may be of the remote service provider itself or a publicly accessible datacenter of a cloud service provider with which the remote service provider has an account. As such, portions of the cloud computing hardware may be dedicated to the remote service provider and additional cloud computing hardware may be dynamically provisioned for the remote service provider on demand.

As described in method 600, the remote service provider may be a coordinating entity to receive indications of emergency events from one or more smart bulbs or other IoT devices at a given location and coordinate a response. As will be seen in FIG. 6, this response may include providing a rapid notification to emergency responding personnel, as well as controlling smart devices within the building to operate in a particular manner, e.g., as predetermined based on policy information for an entity associated with the building, for the indicated emergency event type and the location indicated. Although many different implementations are possible, in one embodiment emergency event indications may be delivered to a remote service provider via a particular combination of an operating system (OS)/cloud computing interface available from Zentri™, namely by interfacing of the smart bulb or other IoT device to the remote service provider via one or more layers of a Zentri™ OS/cloud interface, such as a configuration and/or management console.

Method 600 begins by receiving a secure communication from a smart bulb (block 610). In an embodiment, assume that this secure communication received in the remote service provider is for an emergency alert of a particular type, e.g., gunshot activity. Next it is determined whether the communication is verified (diamond 615). As examples, this determination may be based on decryption of the secure message with an appropriate key to indicate that the message came from a trusted device. The verification may further confirm that the smart bulb is located in its expected location. In some embodiments, the verification may include communication of one or more interrogation messages back to the smart bulb for additional information to verify its authenticity. For example, this interrogation may be to seek personally identifiable information. Note that to further enhance security, the interrogation message itself may be encrypted before being sent to the smart bulb. In turn, the smart bulb to be verified would successfully decrypt the interrogation message, correctly respond to the interrogation message, encrypt the resulting response and send it back to the remote service provider. If the communication is not verified, at block 620 the communication may be discarded. Such non-authenticated emergency reports may be blocked, due to the nature of an armed response to some emergency notifications.

Assuming that the communication is valid, control passes to block 630 where a database of the remote service provider can be accessed. More specifically, an entry for the building can be accessed and in turn, information in this entry, such as a record or subentry for the particular smart bulb, can be accessed. Note that this database that includes building information may include detailed map information including layouts of the different floors of the building, the different rooms located therein, and the corresponding location of smart bulbs and other IoT devices capable of being in communication with the remote service provider. Based at least in part on this information, at block 635 the location of the emergency can be identified. Next, a policy database can be accessed at block 640. This policy database may have an entry for an entity associated with the building and in turn, policy information can be accessed, e.g., based upon the particular emergency alert type.

Various operations may occur concurrently based on the policy information. As illustrated, at block 650 an emergency alert and location information may be sent to one or more emergency responding entities. For example, the policy information may identify particular police department and/or other emergency personnel such as fire department or so forth to be informed of the emergency. Note that this communication from the remote service provider to the emergency responding entity may proceed with low latency and high alert status. For example, a 911 call may be established that identifies with particularity the type of emergency and the particular location of the smart bulb that identified this emergency alert.

As further shown in FIG. 6, the remote service provider may perform further activities, including correlating this emergency alert information with status information from co-located smart bulbs (block 660). For example, the remote service provider can determine whether one or more other emergency alerts or other status messages have been received from co-located smart bulbs or other IoT devices within a small time window. If so, correlation activity may be performed to identify multiple locations in the building at which particular emergency alert types were identified, timing information, direction of travel of a possible threat or so forth.

Still with reference to FIG. 6 based at least in part on location information of the identifying smart bulb (and any correlation information), the building may be partitioned (block 670). More specifically, smart bulbs or other IoT devices may be partitioned into groups based on their relative distance from the emergency alert location. For example, assume a three zone arrangement, where devices within a first relative distance or radius of the identifying smart bulb are partitioned into a first group or zone, devices located within a more distant second radius are partitioned into a second group or zone, and similarly for the third group or zone. Thereafter at block 680, command messages may be sent to the smart bulb groups to operate according to a given policy based on these relative distances. For example, smart bulbs within the first zone can be controlled to operate with a particular color and pattern the same as the identifying smart bulb (e.g., red and flashing). In turn, smart bulbs within the second zone located at an intermediate proximity to the identifying smart bulb may be controlled to operate with a different color and/or pattern (e.g., orange and slowly flashing). And finally, smart bulbs in the building at a further proximity can be controlled to operate with yet another pattern and/or color (e.g., solid and green or so forth). Understand while described with this particular example for purposes of illustration, many variations and alternatives are possible. For example, multiple additional zones can be identified with different control patterns and/or colors to be used for each of these different groups of devices. Furthermore, additional smart devices such as smart actuators for doors, windows or so forth may be similarly controlled to attempt to isolate different zones based on relative distance to an emergency location.

Note that the pattern and color may be selected by a given entity with appropriate selections for different types of emergencies. As a particular example, for detection of a gunshot, after an initial brief alarm, e.g., by automatically blinking all lights in an affected building or campus location, the color of lighting may automatically adjust with regard to distance to the identified location of the gunshot activity. Such color indications may be used by occupants to identify safe directions to flee, as well as to guide responders to the target location. Note further that rapidly blinking lights in an affected area or other lighting pattern may be used to attempt to occupy attention of a perpetrator, to slow down progress and/or to draw gunfire away from occupants.

Note that the remote service provider may issue periodic tests for communication to random devices, and perform maintenance checks. If a policy includes a notification in instances of network and device unavailability, a notice can be sent to administration or building security if there is a failure of smart bulbs to reply to periodic tests.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. An apparatus comprising:
an integrated circuit having a semiconductor die comprising a microcontroller to control operation of one or more light sources and a wireless transceiver to enable communication between the apparatus and a remote service provider; and
at least one microphone coupled to the integrated circuit to detect audio information, wherein in response to receipt of a first audio sample, the microcontroller is to detect an emergency event and communicate an indication of the emergency event to the remote service provider.

2. The apparatus of claim 1, wherein in response to the indication of the emergency event, the one or more light sources are to display a predetermined color.

3. The apparatus of claim 1, wherein the microcontroller is to compare the first audio sample to a gunshot signature to determine whether a gunshot has occurred in a vicinity of the apparatus.

4. The apparatus of claim 3, wherein in response to the comparison to indicate that the gunshot has occurred in the vicinity of the apparatus, the apparatus is to communicate the indication of the emergency event comprising the gunshot to the remote service provider.

5. The apparatus of claim 4, wherein in response to the comparison to indicate that the gunshot has occurred in the vicinity of the apparatus, the apparatus is to communicate a stream of audio information from the microphone to the remote service provider.

6. The apparatus of claim 1, wherein the integrated circuit, after the communication of the emergency event indication, is to receive an interrogation request from the remote service provider, decrypt the interrogation request, prepare an interrogation response, encrypt the interrogation response and send the encrypted interrogation response to the remote service provider.

7. The apparatus of claim 1, wherein the microcontroller is to encrypt the emergency event indication with a hidden key and send the encrypted emergency event indication to the remote service provider based on destination information stored in a local policy.

8. The apparatus of claim 1, wherein the apparatus further comprises at least one sensor to sense an environmental condition, wherein the microcontroller is to detect at least one other emergency event in response to an input received from the at least one sensor, and communicate an indication of the at least one other emergency event to the remote service provider.

9. The apparatus of claim 1, wherein in response to the emergency event detection, the microcontroller is further to send control information to one or more Internet of Things (IoT) devices in communication with the apparatus to cause the one or more IoT devices to take an action according to a policy.

10. The apparatus of claim 9, wherein the control information is to cause a first IoT device comprising an actuator to lock a door.

11. The apparatus of claim 1, wherein the apparatus comprises a smart bulb, and the detection of the emergency event comprises an indication of at least one keyword in the audio information that matches a predetermined keyword.

12-20. (canceled)

21. An apparatus comprising:
a plurality of light emitting diodes to provide illumination;
an integrated circuit coupled to the plurality of light emitting diodes, the integrated circuit having a semiconductor die comprising a microcontroller to control the plurality of light emitting diodes and a wireless transceiver to enable communication between the apparatus and a remote service provider; and
at least one microphone coupled to the integrated circuit to detect audio information, wherein in response to receipt of a first audio sample of the audio information, the microcontroller is to detect an emergency event based at least in part on a match between the first audio sample and a predetermined keyword, communicate an indication of the emergency event to the remote service provider and send control information to one or more Internet of Things (IoT) devices in communication with the apparatus to cause the one or more IoT devices to take an action according to a policy.

22. The apparatus of claim 21, wherein in response to the indication of the emergency event, the microcontroller is to cause the plurality of light emitting diodes to display a predetermined color.

23. The apparatus of claim 21, wherein the microcontroller is to compare the first audio sample to a gunshot signature to determine whether a gunshot has occurred in a vicinity of the apparatus.

24. The apparatus of claim 23, wherein in response to the comparison to indicate that the gunshot has occurred in the vicinity of the apparatus, the apparatus is to communicate the indication of the emergency event comprising the gunshot and a stream of the audio information from the microphone to the remote service provider.

25. The apparatus of claim 21, wherein the integrated circuit, after the communication of the emergency event indication, is to receive an interrogation request from the remote service provider, decrypt the interrogation request, prepare an interrogation response, encrypt the interrogation response and send the encrypted interrogation response to the remote service provider.

26. The apparatus of claim 25, wherein the microcontroller is to encrypt the emergency event indication with a hidden key and send the encrypted emergency event indication to the remote service provider based on destination information stored in a local policy.

27. The apparatus of claim 21, wherein the apparatus further comprises at least one sensor to sense an environmental condition, wherein the microcontroller is to detect at least one other emergency event in response to an input received from the at least one sensor, and communicate an indication of the at least one other emergency event to the remote service provider.

28. The apparatus of claim 21, wherein the control information is to cause a first IoT device comprising an actuator to lock a door.

29. A smart bulb comprising:
a housing;
a plurality of light emitting diodes to provide illumination and adapted in the housing;
an integrated circuit coupled to the plurality of light emitting diodes, the integrated circuit having a semiconductor die comprising a microcontroller to control the plurality of light emitting diodes and a wireless transceiver to enable communication between the smart bulb and a remote service provider;
a non-volatile memory coupled to the integrated circuit, the non-volatile memory to store instructions for execution by the microcontroller; and
at least one audio sensor coupled to the integrated circuit to detect audio information, wherein in response to receipt of a first audio sample of the audio information, the microcontroller is to detect an emergency event based at least in part on a match between the first audio sample and a predetermined keyword, communicate an indication of the emergency event to the remote service provider and send control information to one or more Internet of Things (IoT) devices in communication with the smart bulb to cause the one or more IoT devices to take an action according to a policy.

30. The smart bulb of claim 29, wherein in response to the indication of the emergency event, the microcontroller is to cause the plurality of light emitting diodes to display a predetermined color.

31. The smart bulb of claim 29, wherein the microcontroller is to compare the first audio sample to a gunshot signature to determine whether a gunshot has occurred in a vicinity of the smart bulb.

32. The smart bulb of claim 31, wherein in response to the comparison to indicate that the gunshot has occurred in the vicinity of the smart bulb, the smart bulb is to communicate the indication of the emergency event comprising the gunshot and a stream of the audio information from the audio sensor to the remote service provider.

33. The smart bulb of claim 29, wherein the integrated circuit, after the communication of the emergency event indication, is to receive an interrogation request from the remote service provider, decrypt the interrogation request, prepare an interrogation response, encrypt the interrogation response and send the encrypted interrogation response to the remote service provider.

34. The smart bulb of claim 33, wherein the microcontroller is to encrypt the emergency event indication with a hidden key and send the encrypted emergency event indication to the remote service provider based on destination information stored in a local policy.

35. The smart bulb of claim 29, wherein the apparatus further comprises at least one sensor to sense an environmental condition, wherein the microcontroller is to detect at least one other emergency event in response to an input received from the at least one sensor, and communicate an indication of the at least one other emergency event to the remote service provider.

36. The smart bulb of claim 29, wherein the control information is to cause a first IoT device comprising an actuator to lock a door.
